(19) United States
(12) Patent Application Publication
(10) Pub. No.: US 2016/0366859 A1
(43) Pub. Date: Dec. 22, 2016

(54) LONG RANGE PORTABLE PET OR OWNER INITIATED TWO WAY AUDIO-VIDEO COMMUNICATION DEVICE

(71) Applicants: Seshagiri Venkatesh Prasanna, Bangalore (IN); Shubha Prasanna, Bangalore (IN)

(72) Inventors: Seshagiri Venkatesh Prasanna, Bangalore (IN); Shubha Prasanna, Bangalore (IN)

(21) Appl. No.: 15/183,596

(22) Filed: Jun. 15, 2016

Related U.S. Application Data
(60) Provisional application No. 62/180,085, filed on Jun. 16, 2015.

(51) Int. Cl. A01K 29/00; H04W 4/14; A01K 15/02; H04L 5/00; H04M 1/18; H04L 5/14; H04W 4/00; H04L 12/24

(52) U.S. Cl. CPC A01K 29/005; H04W 4/008; H04W 4/14; H04W 4/003; H04L 41/0681; H04L 5/0055; H04M 1/18; H04L 5/14; A01K 15/021; H04W 84/12

(57) ABSTRACT

A portable device and a method for a domestic pet to contact its master whenever the pet desires so is disclosed. The device comprises of two units and an interconnecting mechanism between them via wireless communication methods such as Bluetooth© or other equivalent RF technologies. The first unit comprises of a circuit board, an antenna, a camera, LCD screen, a speaker, a microphone and a power source all enclosed in a water resistant housing. It is designed to be mounted on a wall semi-permanently by means of flanges at the top and sides or by using an S-hook for temporary mounting. The second unit comprises of a pet friendly and safe tactile momentary switch and dead weight embedded inside it to keep it firmly on the ground. The second unit is designed to be water proof as well to prevent saliva from pets altering the circuit behaviour. The pet can be very easily trained to tap the pet safe switch whenever it desires to reach out to its master. This action is interpreted by the electronics to send a text message and phone call to its master's cellular phone. The device chooses wireless protocols such as Bluetooth, Wi-Fi and GSM/GPRS to establish this communication. Once the communication is established, the pet and owner can hear and see other. The sharing of video is under the control of the master. This invention comprises of an app that is installed on the owner's smart phone to manage all the functions described above. The master can also remotely turn on audio or video of the device to check in on the pet or monitor its behaviour whenever they desire. A “do not disturb” option on the smartphone app lets the master ignore interrupts from overactive pets for a time duration that is configurable in the app itself. Since it is portable, it can be used at home, at a friend's place or even in a pet hotel. The key benefits of this invention is that it reduces stress levels and separation anxiety in pets and owners whenever they are away. It introduces a new paradigm to pet ownership making it easier for pet owners to be away from their pets without guilt knowing that their pet can stay in touch with them whenever they choose to.

### FIELD OF THE INVENTION

The present invention relates to audio video sub systems that make staying in touch with loved ones especially of the four-legged kind possible. In particular, the present invention relates to a device that senses a pet dog's desire to connect with its master and establishes an audio and video enabled communication channel when its master reciprocates. The communication method chosen permits the pet and its owner to connect irrespective of the distance of separation between them.

### BACKGROUND

Pet monitors are in use today to permit anxious pet owners monitor their pets discreetly when they are away from their pets. These monitors serve to keep tabs/spy on their pets to monitor their behaviour, feeding habits etc. These devices are designed to be used inside the owner's home only and serve primarily as a 1-way communication mode where the master always initiates the contact. Given the busy schedules most people nowadays have, it is very common for pet owners to lose track of how long their pets have been alone. Various studies have shown that many pets suffer from separation anxiety when alone and is a leading cause of dog behaviour problems. If the owner's absence is felt for an extended period of time, it starts to border on the lines of animal cruelty as well. The invention described here addresses this problem by giving a trained pet the ability to reach out to its master whenever it desires. This in a way facilities the owner also to be flexible with his/her schedule knowing that the interaction with the pet is at a higher level making pet ownership all the more enjoyable.

### SUMMARY OF THE INVENTION

The present invention discloses a pet or owner initiated audio video conferencing system that establishes a communication channel with its desired owner over Wi-Fi or the GSM/GPRS network. Pet monitors available today are severely limited to the pet owner being able to know the well-being of their pet dog at any time they desire but do not permit the dog from initiating contact with its beloved master when it so desires. When dogs become victims of separation anxiety especially when their owners are away for extended times, they undergo extreme stress. This condition results in tattered carpets, torn sofas/cushions and other mess in the home where the dog resides. This in turn induces stress on the pet owner who returns home and discovers the effort and/or money he/she needs to spend to restore their home to the shape they had left it in. The invention described here reduces separation induced stress in pets and reduces stress and guilt in pet parents for being away from their beloved canines. It is not uncommon to come across dogs that refuse to eat unless their master prods them to do so. The invention disclosed here provides a mechanism for the dog to reach out to its master whenever it needs a little prodding. It gives a pet the ability to view its master at its and its master's discretion. The novelty in this invention is that it uses a cleverly crafted floor/wall mounted device that the dog steps/taps onto to reach out to its master. This device communicates to the audio-video enabled master device via blue tooth or similar RF technologies and generates a trigger. Upon receiving the trigger, the master device notifies the owner on his/her smart phone that its four-legged family member is craving contact with its master. When the master acknowledges, an audio video enabled two way communication is setup. The dog can see and hear its master in the master device and the owner does so on his/her smartphone. This is highly reassuring to the dog as it can see and hear its master as if they were present in the premises. The fact that it has the ability to communicate using Wi-Fi or GSM/GPRS technology, makes it portable thereby permitting its use outside of the owner's home where the owner does not own the Wi-Fi network. Some examples where its portability can be exploited outside a home are pet hotels, over at a friend's place who are watching over the pet temporarily or at the home of elderly parents who do not have Wi-Fi at their home. The fact that it is portable and alerts the owner whenever the pet is in need irrespective of the owner's whereabouts (nearby or half way around the globe) makes it unique.

A provision to disable calls from over active pets is made in the owner's smartphone application. This feature is useful whenever the owner does not want to be disturbed. In this scenario the owner can choose to play a comforting audio/video clip for the pet to reduce its anxiety. The owner can choose to record pet activity and or monitor the pet whenever he/she desires.

### BRIEF DESCRIPTION OF DRAWINGS

These and other features, benefits and advantages of the present invention will become apparent by reference to the following text and figures, with like reference numbers referring to like structures across the view, wherein

FIG. 1 is a block diagram of the device in accordance with an embodiment of the invention;

FIG. 2 illustrates a block diagram of the communication system of the device in accordance with an embodiment of the invention;

FIG. 3 illustrates a block diagram of a microcontroller of the device in accordance with an embodiment of the invention;

FIG. 4 illustrates a flow chart for the detection method in accordance with an embodiment of the invention;

FIG. 5 illustrates the said device referred to as the master device hence forth along with its flange for easy mounting, according to the invention.

FIG. 6 illustrates the said device referred to as the trigger device along with its tactile switch.

### DETAILED DESCRIPTION OF THE INVENTION

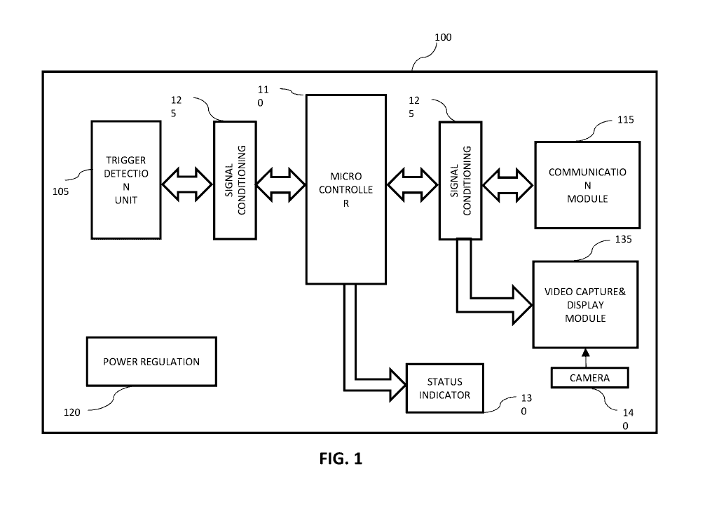

In accordance with the invention, the device 100 (as depicted in FIG. 1) is adapted to detect the pets desire to connect with its master. The device 100 analyses the characteristics of a change in the voltage of a trigger detection unit 105 to determine if the change is indicative of the need to establish a connection. Appropriate filtering is to be applied to suit different embodiments of this invention.

FIG. 1 illustrates a block diagram of the device 100. It includes a trigger detection unit 105, a microcontroller 110, a communications module 115 for transmitting or receiving alerts to and from the owners hand held device, an audio and video capture/display module 135 and/or data and a power regulation module 120.

The trigger detection unit 105 is constructed from a solid-state Bluetooth© module though other types of modules that are RF in nature can also be used in other embodiments of the invention. This module is interfaced with the microcontroller through a signal conditioning block 125, as depicted. The voltage change as a function of time is monitored by the microcontroller 110, which applies filtering to eliminate noise sources from causing false triggers. Once the signal is verified to be true, an encoded digital signature is read from the module to validate that it did indeed come from the paired trigger unit only. This makes the design robust and secure. The module 105, is maintained in an always ON state to provide continual detection. The communication module 115, is responsible for communicating alerts generated by the microcontroller upon detection of the trigger. Depending on the embodiment of the invention, the alert could be in the form of audio/visual indicators only or could include transmitting the alert over a long range media such as a wired network and/or a wireless cellular communication network. The communication module is interfaced to the microcontroller through a signal conditioning block 125, as depicted. This module is managed by the microcontroller and is initialized once per power up and a health check is performed to ensure readiness to communicate any alert. If the module fails the health check, error indications are displayed prominently in the status indicator module 130, for the user to intervene. In addition, the status indicator also presents information on the readiness of the device to begin communication as well as indicating battery status information. The video capture and display module 135 presents the video grabbed from the owners device by streaming it to the display in addition to grabbing video from the camera 140 for transmission to the owner.

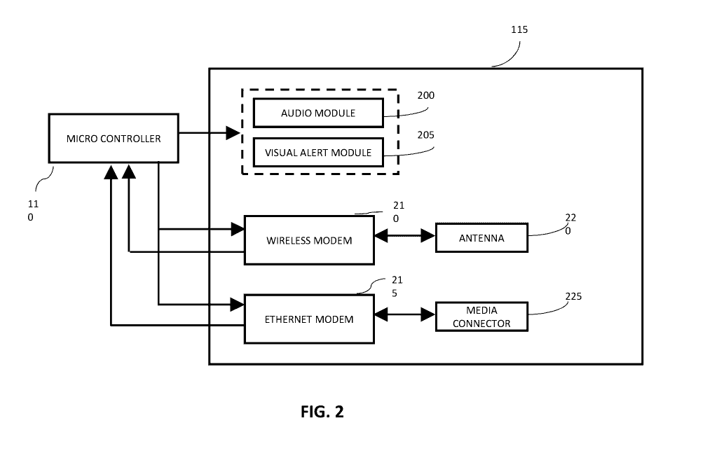

FIG. 2 illustrates a block diagram of the communications module 115. This module generates local and/or long distance alerts when the microcontroller 110 triggers an alert upon detecting a trigger. It comprises of a wireless modem 210 and its associated antenna 220. When a wired LAN option is available, an Ethernet modem 215 along with its media connector 225 may be installed. An audio module 200, which comprises of a speaker and microphone to enable voice communication is included. The visual alert module 205, can be included to generate visual cues and alerts for dogs to help in training as well as an aid for dogs that are losing hearing if the embodiment so requires it.

The wireless modem 210 is responsible for generating a long distance alert. It is a solid state device that transmits a pre-scripted short message alert that it receives from the microcontroller over a valid cellular network or Wi-Fi network. The transmission can also be in the form of email alerts when a valid data network is available. Depending on the user's preference, a single or multiple alerts could be generated to a single or multiple receiving addresses. The device is power managed and is maintained in a standby state when not in use in order to conserve power and extend battery life. The communication with the microcontroller is via a serial interface with signal conditioning on it thereby bringing about electrical compatibility between the modem and the microcontroller. This modem also operates in receive mode when the user desires to configure the device. This is a novel distinguishing feature of this invention as it gives it the ability to accept user inputs in some of the embodiments without utilizing a keypad or LCD screen.

The antenna 220, should accompany the modem 210 in all embodiments of the invention that require long distance alerts. The antenna could be external and/or could be concealed in the casing of the device itself and would serve to improve reception quality and hence the reliability of the device as a security solution. When installed, the Ethernet modem 215 and its associated connector 225, would function in a manner very similar to the wireless modem and transmit/receive alerts and information over a LAN network.

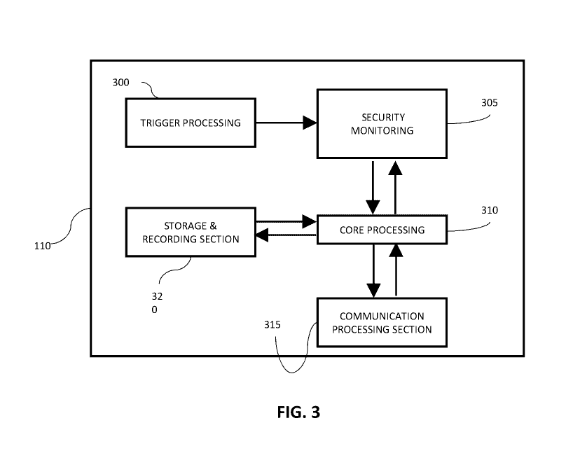

FIG. 3 is a block diagram of the functional blocks in the microcontroller in accordance with an embodiment of the invention. The microcontroller is programmed with firmware that enables the microcontroller 110 to perform the described functionality therein. As depicted in FIG. 3, the microcontroller 110 includes a trigger processing unit 300, a security monitoring section 305, a core processing section 310, a communication processing section 315, and a storage and recording section 320. The implementation of various pre-signal conditioning and digital signature matching functions are implemented by sections 300 and 305. The core processing section 310 is the main routine that integrates all the functions together. The initial behaviour of the system based on the mode of operation chosen by the user, all the processing necessary to process triggers when section 300 indicates so, interfacing with the communications modules and transferring information and data to the recording/storing section is done by the core processing module. The communication processing module delivers all the configuration and data commands required by the modems to transmit and/or receive information. The storage and recording section 320, handles the creation, maintenance and retrieval of subscriber information to which alerts are sent to and information is received from. The necessary parsing and data conditioning is performed on the fly prior to storage of various records. The storage in this embodiment of the invention happens to be the memory space provided by the internal EEPROM of the microcontroller itself. In other embodiments of this invention, more elaborate storage sub systems such as Flash memory could be utilized to store/record several events that are of interest to the user. In other embodiments of this invention, the triggers for generating recording events can come from various other sensing elements other than the one described by 105 thereby expanding the utility of this invention manifold.

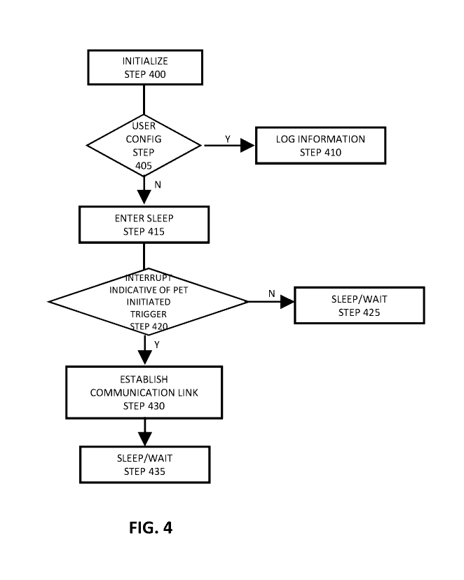

FIG. 4 illustrates a flow chart for a trigger based pet-owner communication method according to an embodiment of the invention.

At step 400, the core processing module 310, initializes the trigger module and the communications modules if present. At step 405, the check for the user's intent is performed. If the user desires to edit/configure the device, the process ends at step 410, where the data received is logged and stored in the permanent storage space such as an EEPROM. If at step 405, the user intent is to use the device for pet-owner communication when the user is not around, the process executes step 415, where the core processing puts the microcontroller in a low power “sleep” mode while being prepared to be interrupted by the trigger module upon receiving a trigger from the pet. The interrupt is configured to be level sensitive to improve noise immunity and prevent false triggers from creating interrupts to the controller. Upon receiving a valid interrupt, step 420 is executed where the interrupt is compared against a set of parameters that are determined based on the application where this invention is utilized. If the interrupt does not qualify to be a trigger, the process culminates at step 425, where the system returns to the sleep state awaiting future interrupts. If the interrupt passes the test, step 430, is executed where the communication and video processing modules are exercised to video stream from the master device to the owners smartphone and vice versa. Upon completion of the video call session, the process culminates in step 435, where the system re-enters sleep state awaiting future interrupts again.

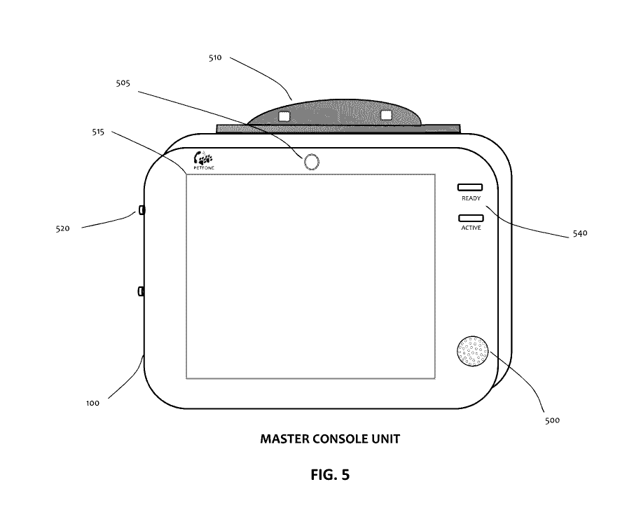

FIG. 5 illustrates the master device that serves as the main console where the pet views its master. It comprises of a circuit board, an antenna, a camera as depicted by 505, a LCD screen depicted by 515, a speaker depicted by 500, a microphone and a power source all enclosed in a water proof housing. It is designed to be mounted on a wall semi-permanently by means of flanges at the top as depicted by 510 or by using an S-hook for temporary mounting. A power on/off switch depicted by 520 and visual status indication by means of LED lights depicted by 540 complete the device 100. The audio interface is capable of full duplex communication and can transmit ambient sound as well as playback the voice of the user when triggered.

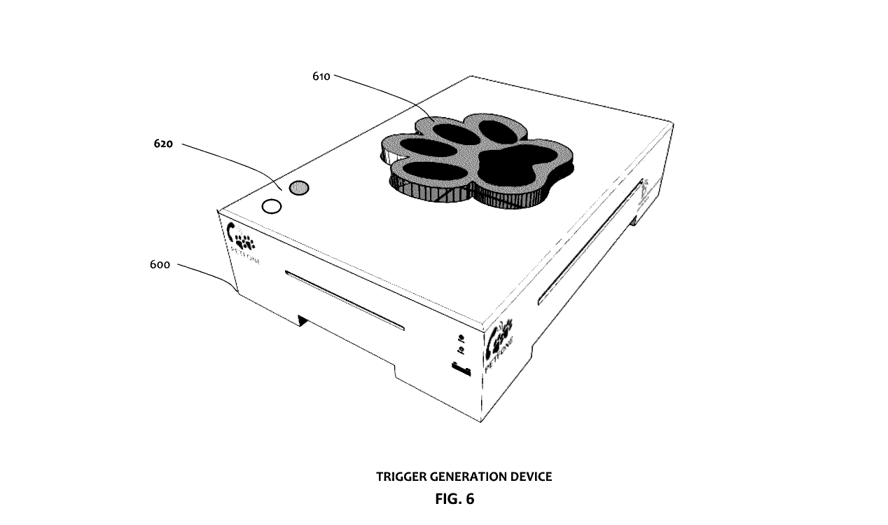

FIG. 6 illustrates the trigger generation device that serves to generate a trigger whenever the pet taps on it. It comprises of a pet friendly and safe tactile momentary switch depicted by 610. This unit is designed to be water proof as well to prevent saliva from pets altering the circuit behaviour. The pet can be very easily trained to tap the pet safe switch whenever it desires to reach out to its master. The visual indicators depicted by 620 serve as visual cues to the pet conveying that its tap was acknowledged by the trigger generation unit. These visual cues would play a critical role in training the pet to get to use the device.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. An apparatus for a pet to initiate a phone call to its master's cellular phone/tablet/personal computer, comprising:
a water proof device that houses:
a pet safe switch that maybe activated mechanically by depressing, rocking or other tactile motion or electronically using sensors;
an electronic circuit board to control this device;
a wireless transmitter and batteries in this housing to communicate with the master console device.

2. The apparatus of claim 1, further comprising of a mechanism to send a pre-programmed text message to its owner upon activation of the pet safe switch by the pet to facilitate a call back from the master.

3. The master console device that interprets the pet initiated action in claim 1, comprising of:
a water proof master console device comprising of:
a Wi-fi and Cellular transmitter and receiver;
a camera and display screen;
a microphone and speaker;
control electronics and a power source;
a capability to record and store data for analysis;
firmware for interpreting the pets intention and setting up a two way audio/video communication between this device and its master's cellular phone/tablet/personal computer.

4. The apparatus of claim 1, further comprising:
visual indicators that serve as cues for training the pet in pet friendly colours;
visual indicators that indicate status of the batteries;
a dead weight that ensures that it stays firmly on any flooring surface such as vinyl/carpet/marble;
a method to adjust the pressure required to depress the tactile momentary switch based on the size of the pet.

5. The method to answer pet initiated calls as per claim 1 when the master wants to be connected by choosing an option on the master's cellular phone/tablet/personal computer.

6. The method to suppress pet initiated calls as per claim 1 when the master does not want to be disturbed by choosing an option on the master's cellular phone/tablet/personal computer.

7. Provide the ability for a pet to establish a full duplex communication with the master's cellular phone/tablet/personal computer per claim 5, with which both the master and the pet can listen in, view and talk through the microphone, camera and speaker integrated into the device.

8. Portability of the apparatus in claim 1 and claim 3 by having the option of using GSM/GPRS as the mode of communication in the apparatus of claim 3.

9. The usage of the apparatus in accordance with claims 1, 2 and 7 reduces stress and anxiety in the pet and its master.

10. A method of collecting vital data using the apparatus of claim 3 by animal trainers, veterinarians and pet enthusiasts on pet behaviour thereby facilitating better quality of care for our pets.
